(19) United States
(12) Patent Application Publication
(10) Pub. No.: US 2009/0234904 A1
(43) Pub. Date: Sep. 17, 2009

(54) System and method for dynamic extension of aggregation engine

(75) Inventors: William R. Dalgliesh, New York, NY (US); Abhiraman Anantharaman, New York, NY (US); Yevgeniv Vishnevetsky, New York, NY (US); Oleg Vernik, Brooklyn, NY (US); Olivier Masdebrieu, Paris (FR); Jeremey Hallenbeck, Highland, NY (US)

Correspondence Address: K&L GATES LLP, 535 SMITHFIELD STREET, PITTSBURGH, PA, 15222, US

(73) Assignee: Morgan Stanley (a Delaware corporation), New York, NY (US)

(21) Appl. No.: 12/283,546

(22) Filed: Sep. 12, 2008

Related U.S. Application Data
(63) Continuation of application No. 12/019,950, filed on Jan. 25, 2008, now abandoned.

(51) Int. Cl. G06F 17/30; G06F 15/16

(52) U.S. Cl. 709/201; 707/101; 707/E17.005

(57) ABSTRACT

Systems and methods for dynamic study management. The method may comprise the steps of: (1) receiving a subscription request at a dynamic study proxy extension engine from a front end for a dynamic study; (2) validating, by the dynamic study proxy extension engine, the subscription request; (3) locating, by the dynamic study proxy extension engine, one or more study templates in response to the subscription request; (4) generating, by the dynamic study proxy extension engine, the dynamic study based on the one or more study templates; (5) uploading, by the dynamic study proxy extension engine, the dynamic study to an aggregation engine; (6) generating, by the aggregation engine, result objects for the dynamic study; (7) creating, by the dynamic study proxy extension engine, a proxy subscription to a publication and subscription server; (8) linking, by the dynamic study proxy extension engine, the dynamic study with the proxy subscription identifier; and (9) transmitting, by the dynamic study proxy extension engine, the proxy subscription identifier to the front end.

### PRIORITY CLAIM

This application is a continuation of U.S. patent application Ser. No. 12/019,950, filed Jan. 25, 2008.

### BACKGROUND

Real-time consolidation and display of data is a common requirement across different processes and systems of many enterprises. For large enterprises, with many distributed processes, the problem of real-time aggregation becomes very complex.

Some known aggregation engines are used to take in data from a variety of sources, define aggregation criteria and calculations to be performed on the input, and deliver the output calculations to a variety of output destinations. Such aggregation engines allow users to monitor large amounts of data in various contexts. These aggregation engines use preconfigured studies to produce all of the data that any one user could possibly want to look at, and users subscribe only to the actual parts of the data in which they are interested. In most cases no individual user is interested in every piece of data that an aggregation engine produces. Also, it is often the case that different users want to see the same data in slightly different ways. In such cases, the aggregation engine generates the data twice. Thus, while such aggregation engines can handle large amounts of data and are highly configurable, they are somewhat inefficient.

### SUMMARY

In one general aspect, the present invention is directed to systems and methods for dynamic study management. The system may comprise a dynamic study proxy extension (DSPE) engine and an aggregation engine. The aggregation engine may calculate result objects for the dynamic studies. The DSPE engine may generate the dynamic studies in response to a subscription request from a front end user and upload the studies to the aggregation engine. The DSPE engine may also obtain a subscription identifier for the front end that is linked to the dynamic study so that the results of the study from the aggregation engine can be published to the front end use.

According to various embodiments, the method may comprise the steps of: (1) receiving a subscription request at the DSPE engine from the front end for a dynamic study; (2) validating, by the DSPE engine, the subscription request; (3) locating, by the DSPE engine, one or more study templates in response to the subscription request; (4) generating, by the DSPE engine, the dynamic study based on the one or more study templates; (5) uploading, by the DSPE engine, the dynamic study to an aggregation engine; (6) generating, by the aggregation engine, result objects for the dynamic study when triggered to do so; (7) creating, by the DSPE engine, a proxy subscription to a publication and subscription server; (8) linking, by the DSPE engine, the dynamic study with the proxy subscription identifier; and (9) transmitting, by the DSPE engine, the proxy subscription identifier to the front end.

### FIGURES

Various embodiments of the present invention are described herein by way of example in conjunction with the following figures, wherein:

FIG. 1 is a diagram of a dynamic study management system according to various embodiments of the present invention;

FIG. 2 is a diagram of the aggregation engine according to various embodiments of the present invention;

FIG. 3 is a diagram illustrating a process flow of the dynamic study management system according to various embodiments of the present invention;

FIG. 4 is a diagram of a process by which a front end user may de-subscribe to a study according to various embodiments;

FIG. 5 is a diagram illustrating the data structure of a study template of the DSPE engine according to various embodiments; and

FIG. 6 is a diagram of a storage unit according to various embodiments of the present invention.

### DETAILED DESCRIPTION

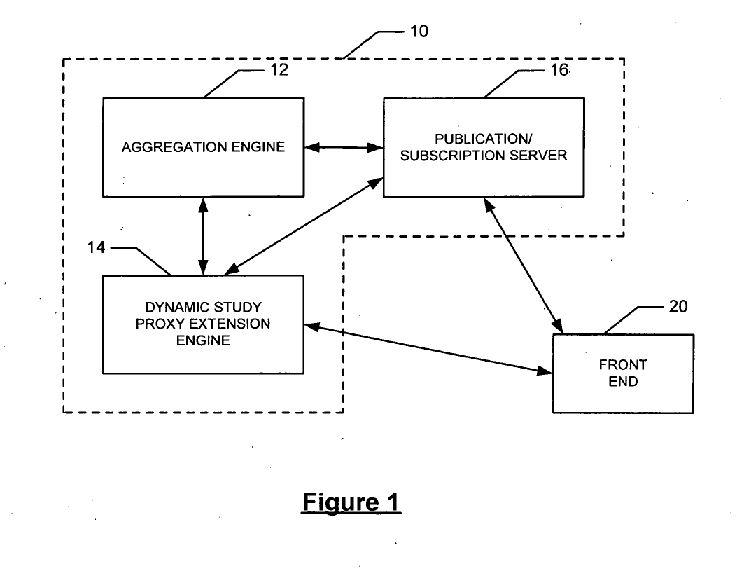

FIG. 1 is a diagram of a dynamic study management system 10 according to various embodiments of the present invention. The system 10 includes an aggregation engine 12, a dynamic study proxy extension engine 14, and a publication/subscription server 16. As described further below, the aggregation engine 12 may produce or generate result objects in response to dynamic studies supplied or uploaded to the aggregation engine 12 by the dynamic study proxy extension engine 14. The dynamic study proxy extension engine 14 may receive subscription requests for dynamic studies from a front end client 20 and, in response, generate the dynamic studies that are supplied to the aggregation engine. The dynamic study proxy extension engine 14 may also create a proxy subscription for the front end 20 to the publication/subscription service 16 and transmit a proxy subscription identifier, that is linked to the dynamic studies, to the front end 20. That way, front end 20 can subscribe to updates to the study using the proxy subscription identifier. The updates may be supplied by the aggregation engine 12 to the publication/subscription server 16 for publication to the end user/front end 20.

The system 10 is particularly useful for enterprises in data intensive fields, such as the financial services industry. As such the system 10 can be used to aggregate data regarding investors' portfolios, trade data, market or trade data for various industry sectors, etc. It should be recognized, however, that although the system 10 is generally described herein in the context of a financial services application, it should be recognized that the system 10 could be used in other contexts.

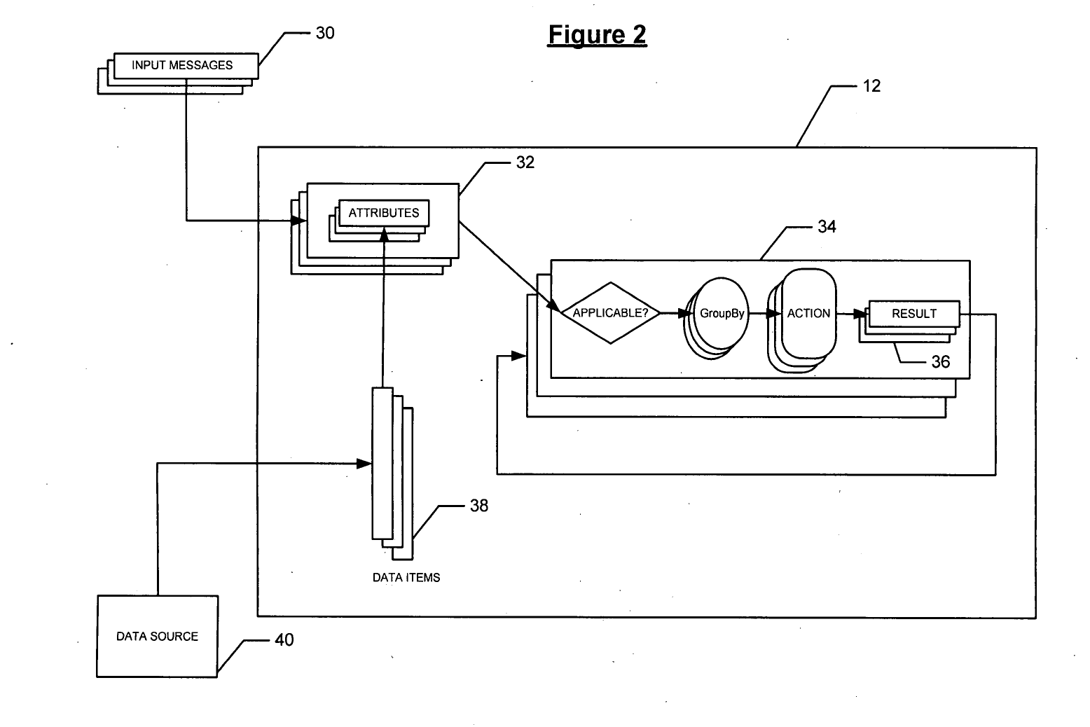

The aggregation engine 12 may be a software-based engine that runs on one or more networked computer devices such servers, personal computers, mainframes, etc. The aggregation engine 12 may aggregate data from a number of data sources (not shown). According to various embodiments, there are three main entities in the aggregation engine 12: state; study; and result. With reference to FIG. 2, a state may be an attribute holder in the aggregation engine 12. All the attributes that are needed for aggregation may be read from incoming messages 30 and stored in states 32. The states may have identities such as, for example, in the financial services context, PortfolioID, OrderID, etc.

According to various embodiments, a study 34 is the entity used by the aggregation engine 12 to configure grouping criteria and conditions to calculate aggregates of the data. Studies may define two main operations: (1) how states are grouped, and once grouped, (2) what actions are needed to be taken to produce the outputs. The grouping may be similar to a SQL “group by” statement in that it may specify that a result set statement returns a list that is grouped by one or more columns, usually in order to apply some sort of aggregate function to certain columns. Each study may consist of condition lists to regulate the states that should be included in a particular group. For each group in a study, a “result” object 36 may be created. The result may be an attribute container (like the state).

The aggregation engine 12 may have at least two operating modes: data collection and calculation. In the data collection mode, the aggregation engine 12 receives data from any number of sources. For example, in a financial services context, the sources may include a FIX (Financial Information exchange) connection, a SOAP (Simple Object Access Protocol) message, etc. The aggregation engine 12 may hold the data in the states 32. The aggregation engine 12 may include parsers specific to each message type (e.g., FIX, SOAP, etc.), which can be configured to read specific items from incoming messages and enrich the states 32. The states 32 may be agnostic about the various message types. As such, multiple parsers can enrich one state 32. For example, a state can be created to represent an order that comes to the aggregation engine 12 on a FIX message. This state can be enriched by other data 38 (e.g., market data) that is published by a different data source 40.

In the calculation mode, calculation cycles may be triggered by an internal timer of the aggregation engine 12, or upon user-defined events or triggers. When a state is updated, it may be marked as changed. During a calculation cycle, the aggregation engine 12 may produce the aggregation results 36 from all the changed states. At the beginning of a calculation cycle, the aggregation engine 12 may first match the changed states which satisfy the conditions and grouping by criteria of a study 34, and add them to the respective groups, formed in that study 34. Then, the calculations may be performed on the updated groups and the aggregates may be produced. The aggregates may be stored in the result objects 36. This process may be repeated for all the studies 34.

As shown in FIG. 2, the input attributes to a study 34 can be either from states 32 or from results 36. Since results 36 may be attribute containers, just as states 32 may be, the results of one study can be used as input to another study. This is how hierarchies of aggregations can be formed. All or part of the results can be published in available formats, as described further below.

The studies 34 may define the aggregations to be performed in the calculation cycles by the aggregation engine 12. There may be many studies in one instance of the aggregation engine 12. The studies can be completely independent or related to each other in that, for example, the results of one study can be the input to another study.

Setting up a study may involve the following steps: (1) define the input source (e.g., input states 32 or the results 36 of another study 34); (2) defining criteria for inclusion in the study; (3) defining the GroupBy criteria; and (4) defining the actions of the group. Setting a condition list lets the user control which states contribute to the results of a study. States 32 can be included or excluded based on their attributes. The studies 34 produce output by performing actions on groups of states, as described further below. The groups may be formed based on the attributes of the states as listed by the GroupBy criteria. For each group in a study 34, the result object 36 is created, and the attributes of the result are the data produced by the actions 42.

To illustrate an example in the financial services context, consider the Table 1 below showing the attributes for three states (State1, State2, and State3).

TABLE 1

| Attribute | State1 | State2 | State3 |
|---|---|---|---|
| clientID | AAA | AAA | BBB |
| OrderID | OID1 | OID2 | OID3 |
| Side | B | S | B |
| tradePrice | 54.22 | 33.23 | 41.10 |
| openQuantity | 100 | 200 | 150 |

This table shows attributes for three trade orders by two different clients (AAA and BBB). The states may be created from order data received into the aggregation engine 12 as FIX messages or some other message type. The “B” for “Side”-indicates the order is a buy order and the “S” indicates it is a sell order.

Table 2 below indicates how three studies might be configured.

TABLE 2

| | Study1 | Study2 | Study3 |
|---|---|---|---|
| Input Type | State | State | Results of |
| | | | Study 2 |
| Condition list | tradePrice > 40 | None | None |
| GroupBy | Side | clientID, | clientID |
| Attributes | | orderID | |
| Action | Sum the value | Sum value | Sum value |
| | (tradePrice * openQuantity) | Sum Open | |
| | | Quantity | |

In this example, Study1 is the only study to include a condition list and will only act on State 1 and State 3 since they satisfy the tradePrice condition of Study1 (see Table 1). In this example, Study1 will aggregate both of the states into one group because they both have the same side. Study1 will therefore produce only one Result object, and that Result will have only one Attribute: value, producing 11587.00.

Study2 will include all three states since it does not define a condition list. Each of the states will form its own group, since the attribute pair of clientID and orderID is unique for each of these states. Study2 will, therefore, produce three result objects, with two attributes each: value and openQuantity: (5422, 100), (6646, 200), (6165, 150).

Study 3 is configured to use the results of Study2 as input. Since it has no condition list, all three of the results that Study2 produced will be included. The results of Study2 will be aggregated into two groups, since the GroupBy list for Study3 contains only the clientID. Study3 is configured to produce only one attribute on the results: value. The values will be 12,068 for the result with clientID=Bmw, and 6165 for the Result with clientID=Axa.

Note that, according to various embodiments, a study with no GroupBy criteria will aggregate every input state into one group. Note also, that the existence of GroupBy attributes on the input state represents implicit conditions on the study. A state will not be included in a study if it does not have a value for any of the GroupBy attributes, even if the state fits the explicit conditions defined in the study. And finally, note that studies can be configured to receive either raw states as input or the results from other Studies, but not both at one time, according to various embodiments.

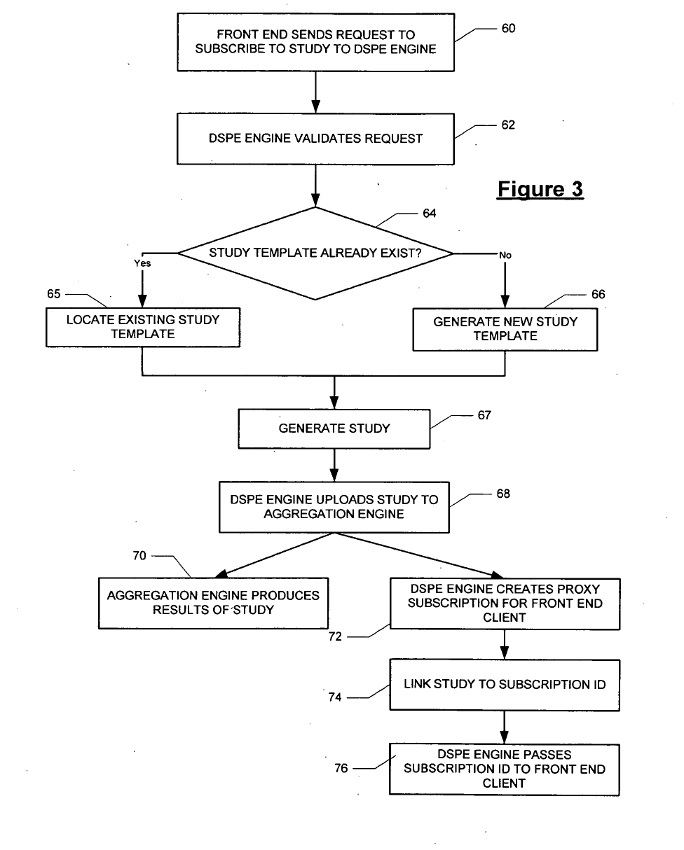

The aggregation engine 12 may format the results according to various formats, such as XML, FIX, SOAP, etc. FIG. 3 is a block diagram of the general structure of a configuration file for the aggregation engine 12. As shown in FIG. 3, the configuration file may comprise general items 50, resource specifications 52, and services 54. The following is an example of a configuration file for the aggregation engine 12.

Sample Configuration File

```
<!DOCTYPE ETSApp:Config SYSTEM
“/ms/dist/OR/PROJ/etsStudyEngine/4.0.3/common/include/ESE/ESE.dtd” [
    <!ENTITY ProcName “SampleESE”>
    <!ENTITY ProcNum “1”>
    <!ENTITY TestSuffix “-g”>
    <!ENTITY Host “paias461”>
    <!ENTITY Port “17010”>
    <!ENTITY OutCPSHost “paias461”>
    <!ENTITY OutCPSPort “58800”>
    <!ENTITY OutCPSBackupHost “paias461”>
    <!ENTITY OutCPSBackupPort “58800”>
    <!ENTITY CPSPubTopic “SampleESE”>
]>
<ETSApp:Config application=“EtsStudyEngine” version=“4.0.3”>
  <AdminMgr>
      <Address>&Host;:&Port;</Address>
  </AdminMgr>
  <RuntimePath>/var/tmp/ESE/&ProcName;&ProcNum;</RuntimePath>
  <Resources>
      <ETSApp:FixRouter>
        <FixRtr:FixRouter mode=“Resource”>
          <Protocols>
            <FixMSNet>
              <FixMSNetListenAddress>:ese_app_test1</FixMSNetListenAddress>
            </FixMSNet>
          </Protocols>
        </FixRtr:FixRouter>
      </ETSApp:FixRouter>
      <ETSApp:CPSPublisherMgr>
        <ClassicPublisher name=“cpsOut” persistent=“N”>
          <Address>&OutCPSHost;:&OutCPSPort;</Address>
          <BackupAddress>&OutCPSBackupHost;:&OutCPSBackupPort;</BackupAddress>
        </ClassicPublisher>
        <CPSMgr:LogModes>
          <CPSMgr:LogCPSHeader mode=“On”/>
          <CPSMgr:LogCPSBody mode=“On”/>
        </CPSMgr:LogModes>
      </ETSApp:CPSPublisherMgr>
      <ETSApp:TimerMgr />
  </Resources>
  <Services>
      <!-- input transport services -->
      <ESEFixRouterTransport:ESEFixRouterTransport name=“FixData”>
        <EventSubscriptions>
          <ETSApp:FixMsgEvent>
          </ETSApp:FixMsgEvent>
        </EventSubscriptions>
      </ESEFixRouterTransport:ESEFixRouterTransport>
      <ESE:EtsStudyEngine name=“ese” publishThreshold=“20000”
publishAll=“true”>
        <AllStatesMap numberOfRecords=“60000” recordSize=“1970”
resizeNumber=“20000”/>
        <FilterTransportServiceName>FilterData</FilterTransportServiceName>
        <MessageParsers>
          <Event type=“FixData”> <!-- fix router transport service -->
            <Parser type=“FixSingleOrder”>
              <MessageTypes>
                <MessageType>ExecutionReport</MessageType>
                <MessageType>OrderCancelReject</MessageType>
              </MessageTypes>
              <EntityTypes>
                <EntityType>
                  <SetupList>
                    <Setup>
                      <Methods>
                        <Method type=“Const”>OrderState</Method>
                      </Methods>
                    </Setup>
                  </SetupList>
                </EntityType>
              </EntityTypes>
            </Parser>
          </Event>
        </MessageParsers>
        <StateDefinitions>
        <StateDefinition name=“OrderState”>
            <StateIDDef>
              <KeyComponents>
              <Field name=“PortfOrderID”/>
              </KeyComponents>
            </StateIDDef>
          <StateWatchListNames>
            <WLName>OrderList</WLName>
            </StateWatchListNames>
          </StateDefinition>
        </StateDefinitions>
        <StateWatchLists>
          <WatchList name=“OrderList”>
            <Field name=“PortfOrderID”/> <!-- 10172 -->
            <Field name=“PortfolioID”/> <!-- 7275 -->
            <Field name=“Symbol”/> <!-- 55 -->
            <Field name=“OrderQty” threshold=“0.001”/> <!-- 38 -->
            <Field name=“Side”> <!-- 54 -->
            <SetupList>
                <Setup>
                    <Methods>
                      <Method type=“EnumToString”>
                        <EnumType>OrderSide</EnumType>
                        <FieldName>Side</FieldName>
                      </Method>
                </Methods>
            </Setup>
              </SetupList>
            </Field>
          </WatchList>
        </StateWatchLists>
        <OutputTransports>
          <Transport>
            <Type>OutputCPS</Type>
            <Alias>output_410_cps</Alias>
            <ResourceName>cpsOut</ResourceName>
            <ConstParams>
              <ConstParam name=“mode”>absolute</ConstParam>
              <ConstParam name=“exptime”>23:00:00</ConstParam>
              <ConstParam name=“topic”>&CPSPubTopic;</ConstParam>
            </ConstParams>
          </Transport>
        </OutputTransports>
      <PublishKeys>
          <DestinationPKs name=“output_410_cps”>
            <PublishKey>
              <Name>/Result/StudyID</Name>
              <Value>
                <Component type=“StudyNameLookup”/>
              </Value>
            </PublishKey>
            <PublishKey>
              <Name>/Result/GBKey</Name>
              <Value>
                <Component type=“GBKeyLookup”/>
              </Value>
            </PublishKey>
          </DestinationPKs>
      </PublishKeys>
      <Studies>
        <Study reactToExternal=“true” includeNonLeafStates=“true”
rematchChanged=“true” name=“TestStudy”>
          <StateTypes>
            <StateType value=“State”/>
          </StateTypes>
          <Life>
            <PublishPeriod>1</PublishPeriod>
          </Life>
          <StudyOutputDefinitions>
            <ActionOutputDefinitions useDelta=“true” name=“NewDeltable”>
              <OutputDefinition name=“OrderQty” type=“SimpleCalculable”>
                <AttributeDefinition outputterType=“String”/>
                <Inputs/>
                <Destinations>
                  <Destination name=“output_410_cps”>
                    <PublishAlias>
                      <Component type=“Const”>/Result/OrderQty</Component>
                    </PublishAlias>
                </Destination>
                </Destinations>
              </OutputDefinition>
            </ActionOutputDefinitions>
            <ActionOutputDefinitions name=“Proxy”>
                <OutputDefinition name=“PortfolioID” type=“SimpleOutput”>
                  <AttributeDefinition outputterType=“String”/>
                  <Inputs>
                      <Input>PortfolioID</Input>
                  </Inputs>
                  <Destinations>
                <Destination name=“output_410_cps”>
                  <PublishAlias>
                    <Component type=“Const”>/Result/PortfolioID</Component>
                        </PublishAlias>
                      </Destination>
                  </Destinations>
            </OutputDefinition>
                  <OutputDefinition name=“Symbol” type=“SimpleOutput”>
                  <AttributeDefinition outputterType=“String”/>
                  <Inputs>
                        <Input>Symbol</Input>
                  </Inputs>
                  <Destinations>
              <Destination name=“output_410_cps”>
                        <PublishAlias>
                      <Component type=“Const”>/Result/Symbol</Component>
                        </PublishAlias>
                      </Destination>
                </Destinations>
              </OutputDefinition>
              <OutputDefinition name=“Side” type=“SimpleOutput”>
                <AttributeDefinition outputterType=“String”/>
                <Inputs>
                    <Input>Side</Input>
                </Inputs>
                <Destinations>
                <Destination name=“output_410_cps”>
                  <PublishAlias>
                    <Component type=“Const”>/Result/Side</Component>
                        </PublishAlias>
                      </Destination>
                </Destinations>
              </OutputDefinition>
            </ActionOutputDefinitions>
          </StudyOutputDefinitions>
          <Conditions>
            <Condition>
              <LHS level=“Self”>OrderQty</LHS>
              <RHS>100</RHS>
              <Relation>DoubleGreater</Relation>
            </Condition>
          </Conditions>
          <GroupByKeys>
            <GroupByKey level=“Self”>PortfolioID</GroupByKey>
            <GroupByKey level=“Self”>Symbol</GroupByKey>
            <GroupByKey level=“Self”>Side</GroupByKey>
          </GroupByKeys>
        </Study>
        <Study reactToExternal=“true” includeNonLeafStates=“true”
rematchChanged=“true” name=“TestStudy_Tier2”>
          <StateTypes>
            <StateType value=“OutputItem”/>
          </StateTypes>
          <Life>
            <PublishPeriod>1</PublishPeriod>
          </Life>
          <Dependencies>
            <Dependency>TestStudy</Dependency>
          </Dependencies>
          <StudyOutputDefinitions>
            <ActionOutputDefinitions useDelta=“true” name=“NewDeltable”>
              <OutputDefinition name=“OrderQty” type=“SimpleCalculable”>
              <AttributeDefinition outputterType=“String”/>
              <Inputs/>
              <Destinations>
              <Destination name=“output_410_cps”>
                <PublishAlias>
                  <Component type=“Const”>/Result/OrderQty</Component>
                    </PublishAlias>
                  </Destination>
                  </Destinations>
              </OutputDefinition>
            </ActionOutputDefinitions>
            <ActionOutputDefinitions name=“Proxy”>
                <OutputDefinition name=“Side” type=“SimpleOutput”>
                    <AttributeDefinition outputterType=“String”/>
                    <Inputs>
                      <Input>Side</Input>
                    </Inputs>
                    <Destinations>
                  <Destination name=“output_410_cps”>
                      <PublishAlias>
                      <Component type=“Const”>/Result/Side</Component>
                        </PublishAlias>
                      </Destination>
                    </Destinations>
                </OutputDefinition>
            <OutputDefinition name=“Symbol” type=“SimpleOutput”>
                    <AttributeDefinition outputterType=“String”/>
                    <Inputs>
                      <Input>Symbol</Input>
                    </Inputs>
                    <Destinations>
                  <Destination name=“output_410_cps”>
                    <PublishAlias>
                      <Component type=“Const”>/Result/Symbol</Component>
                    </PublishAlias>
                  </Destination>
                </Destinations>
                </OutputDefinition>
              </ActionOutputDefinitions>
            </StudyOutputDefinitions>
          <GroupByKeys>
          <GroupByKey level=“Self”>Symbol</GroupByKey>
            <GroupByKey level=“Self”>Side</GroupByKey>
            </GroupByKeys>
          </Study>
        </Studies>
      <ParseInfo>
      <Field name=“PortfolioID”>
        <Methods>
          <Method type=“FixSingleOrder”>
            <Paths>
              <Path>PortfolioID</Path>
            </Paths>
          </Method>
        </Methods>
        </Field>
        <Field name=“PortfOrderID”>
          <Methods>
          <Method type=“FixSingleOrder”>
              <Paths>
                <Path>10172</Path>
              </Paths>
            </Method>
        </Methods>
        </Field>
        <Field name=“Symbol”>
          <Methods>
            <Method type=“FixSingleOrder”>
              <Paths>
                <Path>Symbol</Path>
              </Paths>
            </Method>
          </Methods>
        </Field>
        <Field name=“OrderQty”>
          <Methods>
          <Method type=“FixSingleOrder”>
            <Paths>
              <Path>OrderQty</Path>
            </Paths>
          </Method>
        </Methods>
      </Field>
      <Field name=“Side”>
        <Methods>
          <Method type=“FixSingleOrder”>
            <Paths>
              <Path>Side</Path>
            </Paths>
            </Method>
        </Methods>
        </Field>
      </ParseInfo>
  </ESE:EtsStudyEngine>
      <ESERecalcManager:ESERecalcManager>
        <EventSubscriptions>
          <ETSApp:TimerEvent>
            <TimerName>RecalcTimer</TimerName>
          </ETSApp:TimerEvent>
          <ESERecalcManager:RecalcEvent/>
        </EventSubscriptions>
        <Timer>
          <ETSApp:Interval name=“RecalcTimer” interval=“30”/>
        </Timer>
    </ESERecalcManager:ESERecalcManager>
  </Services>
</ETSApp:Config>
```

The following are example of six FIX messages that may be input to the configuration file provided above.

8=FIX.4.1;9=0;35=8;34=0;52=20040916-11:34:45;7275=P1;7203=ETS;10165=B-
ES110NLZKV00:zxzzt:q-
1;55=IBM;48=ZXZZT;22=8;7319=PQ30ZYL7X100;54=1;7225=N;38=10;10172=O1;7225=AC;38
=200;7203=ETS;10365=PassportXL;10113=0;75=20040916;7339=20040916-
11:34:45; 7401=NY; 7509=20040916-11:34:45;10384=20040916-
11:34:45;10016=EDT;10020=EDT;7319=PQ30ZYL7X100;10014=PQ30ZYL7X300;7338=moorej
o@ms.com;60=20040916-
11:34:45;7299=moorejo@ms.com;73=1;15=USD;100=O;436=1;7203=ETS;7239=100;7253=z
xzzt.q;10014=PQ30ZYL7X300;7324=STOCK;7338=moorejo@ms.com;7339=20040916-
11:34:45;7401=NY;7509=20040916-
11:34:45;10016=EDT;10020=EDT;10113=0;60=20040916-
11:34:45;47=Y;10161=1;7401=NY;7509=20040916-11:34:18;7339=20040916-
11:34:45;10113=2;7549=I;10=000;
8=FIX.4.1;9=0;35=8;34=0;52=20040916-11:34:45;7275=P1;7203=ETS;10165=B-
ES110NLZKV00:zxzzt:q-
1;55=IBM;48=ZXZZT;22=8;7319=PQ30ZYL7X100;54=2;7225=N;38=10;10172=O2;7225=AC;38
=300;7203=ETS;10365=PassportXL;10113=0;75=20040916;7339=20040916-
11:34:45;7401=NY;7509=20040916-11:34:45;10384=20040916-
11:34:45;10016=EDT;10020=EDT;7319=PQ30ZYL7X100;10014=PQ30ZYL7X300;7338=moorej
o@ms.com;60=20040916-
11:34:45;7299=moorejo@ms.com;73=1;15=USD;100=O;436=1;7203=ETS;7239=100;7253=z
xzzt.q;10014=PQ30ZYL7X300;7324=STOCK;7338=moorejo@ms.com;7339=20040916-
11:34:45;7401=NY;7509=20040916-
11:34:45;10016=EDT;10020=EDT;10113=0;60=20040916-
11:34:45;47=Y;10161=1;7401=NY;7509=20040916-11:34:18;7339=20040916-
11:34:45;10113=2;7549=I;10=000;
8=FIX.4.1;9=0;35=8;34=0;52=20040916-11:34:45;7275=P1;7203=ETS;10165=B-
ES110NLZKV00:zxzzt:q-
1;55=CSCO;48=ZXZZT;22=8;7319=PQ30ZYL7X100;54=1;7225=N;38=10;10172=O3;7225=AC;
38=200;7203=ETS;10365=PassportXL;10113=0;75=20040916;7339=20040916-
11:34:45;7401=NY;7509=20040916-11:34:45;10384=20040916-
11:34:45;10016=EDT;10020=EDT;7319=PQ30ZYL7X100; 10014=PQ30ZYL7X300;7338=moorej
o@ms.com;60=20040916-
11:34:45;7299=moorejo@ms.com;73=1;15=USD;100=O;436=1;7203=ETS;7239=100;7253=z
xzzt.q;10014=PQ30ZYL7X300;7324=STOCK;7338=moorejo@ms.com;7339=20040916-
11:34:45;7401=NY;7509=20040916-
11:34:45;10016=EDT;10020=EDT;10113=0;60=20040916-
11:34:45;47=Y;10161=1;7401=NY;7509=20040916-11:34:18;7339=20040916-
11:34:45;10113=2;7549=I;10=000;
8=FIX.4.1;9=0;35=8;34=0;52=20040916-11:34:45;7275=P1;7203=ETS;10165=B-
ES110NLZKV00:zxzzt:q-
1;55=IBM;48=ZXZZT;22=8;7319=PQ30ZYL7X100;54=2;7225=N;38=10;10172=O4;7225=AC;38
=100;7203=ETS; 10365=PassportXL;10113=0;75=20040916;7339=20040916-
11:34:45;7401=NY;7509=20040916-11:34:45;10384=20040916-
11:34:45;10016=EDT;10020=EDT;7319=PQ30ZYL7X100;10014=PQ30ZYL7X300;7338=moorej
o@ms.com;60=20040916-
11:34:45;7299=moorejo@ms.com;73=1;15=USD;100=O;436=1;7203=ETS;7239=100;7253=z
xzzt.q;10014=PQ30ZYL7X300;7324=STOCK;7338=moorejo@ms.com;7339=20040916-
11:34:45;7401=NY;7509=20040916-
11:34:45;10016=EDT;10020=EDT;10113=0;60=20040916-
11:34:45;47=Y;10161=1;7401=NY;7509=20040916-11:34:18;7339=20040916-
11:34:45;10113=2;7549=I;10=000;
8=FIX.4.1;9=0;35=8;34=0;52=20040916-11:34:45;7275=P2;7203=ETS;10165=B-
ES110NLZKV00:zxzzt:q-
1;55=CSCO;48=ZXZZT;22=8;7319=PQ30ZYL7X100;54=2;7225=N;38=10;10172=O5;7225=AC;
38=500;7203=ETS;10365=PassportXL;10113=0;75=20040916;7339=20040916-
11:34:45;7401=NY;7509=20040916-11:34:45;10384=20040916-
11:34:45;10016=EDT;10020=EDT;7319=PQ30ZYL7X100;10014=PQ30ZYL7X300;7338=moorej
o@ms.com;60=20040916-
11:34:45;7299=moorejo@ms.com;73=1;15=USD;100=O;436=1;7203=ETS;7239=100;7253=z
xzzt.q;10014=PQ30ZYL7X300;7324=STOCK;7338=moorejo@ms.com;7339=20040916-
11:34:45;7401=NY;7509=20040916-
11:34:45;10016=EDT;10020=EDT;10113=0;60=20040916-
11:34:45;47=Y;10161=1;7401=NY;7509=20040916-11:34:18;7339=20040916-
11:34:45;10113=2;7549=I;10=000;
8=FIX.4.1;9=0;35=8;34=0;52=20040916-11:34:45;7275=P2;7203=ETS;10165=B-
ES110NLZKV00:zxzzt:q-
1;55=CSCO;48=ZXZZT;22=8;7319=PQ30ZYL7X100;54=1;7225=N;38=10;10172=O6;7225=AC;
38=200;7203=ETS;10365=PassportXL;10113=0;75=20040916;7339=20040916-
11:34:45;7401=NY;7509=20040916-11:34:45;10384=20040916-
11:34:45;10016=EDT;10020=EDT;7319=PQ30ZYL7X100;10014=PQ30ZYL7X300;7338=moorej
o@ms.com;60=20040916-
11:34:45;7299=moorejo@ms.com;73=1;15=USD;100=O;436=1;7203=ETS;7239=100;7253=z
xzzt.q;10014=PQ30ZYL7X300;7324=STOCK;7338=moorejo@ms.corn;7339=20040916-
11:34:45;7401=NY;7509=20040916-
11:34:45;10016=EDT;10020=EDT;10113=0;60=20040916-
11:34:45;47=Y;10161=1;7401=NY;7509=20040916-11:34:18;7339=20040916-
11:34:45;10113=2;7549=I;10=000;

The corresponding output from the aggregation engine 12 for these input FIX messages and the configuration code provided above, in XML, would be:

```
<?xml version=“1.0” encoding=“UTF-8”?>
<Result>
  <StudyID>TestStudy</StudyID>
  <GBKey>P1:IBM:Sell</GBKey>
  <Side>Sell</Side>
  <Symbol>IBM</Symbol>
  <OrderQty>300</OrderQty>
  <PortfolioID>P1</PortfolioID>
</Result>
<?xml version=“1.0” encoding=“UTF-8”?>
<Result>
  <StudyID>TestStudy</StudyID>
  <GBKey>P2:CSCO:Buy</GBKey>
  <Side>Buy</Side>
  <Symbol>CSCO</Symbol>
  <OrderQty>200</OrderQty>
  <PortfolioID>P2</PortfolioID>
</Result>
<?xml version=“1.0” encoding=“UTF-8”?>
<Result>
  <StudyID>TestStudy</StudyID>
  <GBKey>P1:CSCO:Buy</GBKey>
  <Side>Buy</Side>
  <Symbol>CSCO</Symbol>
  <OrderQty>200</OrderQty>
  <PortfolioID>P1</PortfolioID>
</Result>
<?xml version=“1.0” encoding=“UTF-8”?>
<Result>
  <StudyID>TestStudy</StudyID>
  <GBKey>P1:IBM:Buy</GBKey>
  <Side>Buy</Side>
  <Symbol>IBM</Symbol>
  <OrderQty>200</OrderQty>
  <PortfolioID>P1</PortfolioID>
</Result>
<?xml version=“1.0” encoding=“UTF-8”?>
<Result>
  <StudyID>TestStudy</StudyID>
  <GBKey>P2:CSCO:Sell</GBKey>
  <Side>Sell</Side>
  <Symbol>CSCO</Symbol>
  <OrderQty>500</OrderQty>
  <PortfolioID>P2</PortfolioID>
</Result>
<?xml version=“1.0” encoding=“UTF-8”?>
<Result>
  <StudyID>TestStudy_Tier2</StudyID>
  <GBKey>IBM:Buy</GBKey>
  <Side>Buy</Side>
  <Symbol>IBM</Symbol>
  <OrderQty>200</OrderQty>
</Result>
<?xml version=“1.0” encoding=“UTF-8”?>
<Result>
  <StudyID>TestStudy_Tier2</StudyID>
  <GBKey>CSCO:Buy</GBKey>
  <Side>Buy</Side>
  <Symbol>CSCO</Symbol>
  <OrderQty>400</OrderQty>
</Result>
<?xml version=“1.0” encoding=“UTF-8”?>
<Result>
  <StudyID>TestStudy_Tier2</StudyID>
  <GBKey>CSCO:Sell</GBKey>
  <Side>Sell</Side>
  <Symbol>CSCO</Symbol>
  <OrderQty>500</OrderQty>
</Result>
<?xml version=“1.0” encoding=“UTF-8”?>
<Result>
  <StudyID>TestStudy_Tier2</StudyID>
  <GBKey>IBM:Sell</GBKey>
  <Side>Sell</Side>
  <Symbol>IBM</Symbol>
  <OrderQty>300</OrderQty>
</Result>\
```

Referring back to FIG. 1, the dynamic study proxy extension (DSPE) engine 14 may also be a software-based engine that runs on one or more computer devices. The DSPE engine 14 may run on the same computer device(s) as the aggregation engine 12 or a different one(s). According to various embodiments, the DSPE engine 14 provides an extension service for the aggregation engine 12 that allows dynamic creation, update and deletion of studies. The DSPE engine 14 may also create proxy subscriptions on the client request and maintain persistent state of the studies and their subscriptions. With this functionality, data may be produced on demand when a client demonstrates a desire to see it. This may considerably lighten the computational and data delivery loads on the aggregation engine 12. The DSPE engine 14 may also allow the aggregation engine 12 to act on the objects that it is monitoring. Instead of being limited to viewing calculated totals on the input states, the DSPE engine 14 can allow users to take actions on the constituents of the aggregated groups.

According to various embodiments, one of the functions of the DSPE engine 14 is decoupling the backend actions of the aggregation engine 12 from the GUI of the front end 20 and hiding implementation details by providing a simple API (such as a SOAP API). According to various embodiments, the DSPE engine 14 may hide from the GUI the fact that dynamic studies exist at all. The GUI does not need to know anything about how the data is created; it may just send a subscription request from the front end 20 for what data it wants to see, and the results are returned by the system 10. The DSPE engine 14, according to various embodiments, knows how to create the studies, and also when to create the studies. It may have an internal map of the studies that already exist, and which end users or subscribers are still looking at them. If a user requests new data that was already produced by another user, the study is shared among the two end users. If one of the users wants a superset of a study that already exists, the existing study is modified to include the additional data. When all users are done with a study, it may be deleted. According to one embodiment, the DSPE engine 14 may send a dynamic study delete command to the aggregation engine 12 to cause the aggregation engine 12 to delete the study.

The publication/subscription server 16 may publish data and/or files to users (such as a user at the front end 20) where the user has subscribed to such data/files. Each subscription may have an associated identifier (ID).

FIG. 3 is a diagram of a process flow of the system 10 according to various embodiments of the present invention. At step 60, the front end 20 sends a request to subscribe to a study or set of studies (“a subscription request”) to the DSPE engine 14 via a network (e.g., LAN). The request may be sent using a XML format, for example, and may specify the conditions and the GroupBy fields of the study template. At step 62, the DSPE engine 14 may validate the subscription request from the front end. If valid, at step 64 the DSPE engine 14 determines whether the study template already exists. The DSPE engine 14 may perform this function using an internal map of the studies, as described herein. If a study template exists, at step 65 the DSPE engine 14 locates the existing study template and, at step 67, the DSPE engine 14 generates the study using the study template for the subscription request. If a study template does not exist, at step 66 the DSPE engine 14 generates a new study template based on the requested conditions and, at step 67, generates the study using the new study template.

At step 68, the DSPE engine 14 uploads the study to the aggregation engine 12. When triggered, the aggregation engine 12 then produces the results of the study at step 70, which are delivered to the publication/subscription service 16 for publication. In addition, the DSPE engine 14 creates a proxy subscription to the publication/subscription server 16 on behalf of the client (at the front end 20) at step 72. At step 74, the DSPE engine 14 may link the new study to the proxy subscription identifier (ID). At step 76, the DSPE engine 14 passes the subscription ID back to the front end so that the front end can be subscribed for updates to the dynamic study using the subscription ID. The DSPE engine 14 may also update the internal study map to indicate the linkage between then study and the subscription ID. The DSPE engine 14 may also increment by one the reference counter because of the subscription.

According to various embodiments, if the subscription request is for a study that already exists, the DSPE engine 14 can avoid recreating the study by merely incrementing the reference counter for the study, obtaining a subscription ID from the publication/subscription server 16, linking the subscription ID to the study, and transmitting the subscription ID to the front end user.

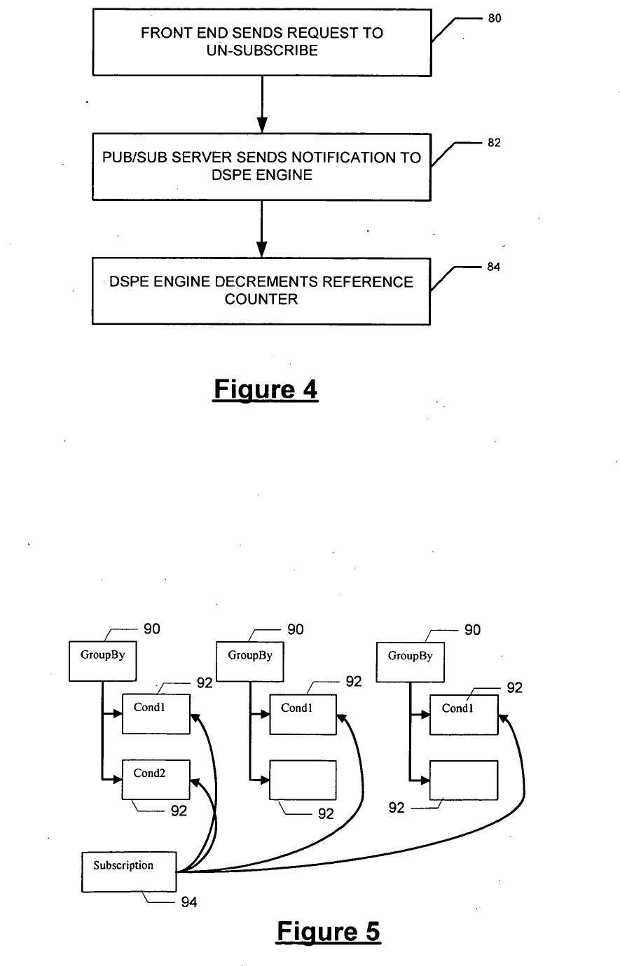

FIG. 4 is a diagram of a process by which a front end user may de-subscribe to a study according to various embodiments. At step 80, the front end user may send a request to unsubscribe to the study to the publication/subscription server 16. At step 82, the publication/subscription server 16 sends a notification to the DSPE engine 14 about the request to de-subscribe to the study by the front end user. At step 84, the DSPE engine 14 locates the study by subscription ID and decrements the reference counter for the study. If the study's reference counter reaches zero through such decrements, the DSPE engine 14 may remove the study from its maps and issue a command to the aggregation engine 12 to delete the study.

FIG. 5 is a diagram illustrating the data structure of a study template of the DSPE engine 14 according to various embodiments. The study template includes the study's GroupBy fields 90. Each GroupBy field represents a collection of conditions 92. In FIG. 5 each GroupBy field is shown as having two conditions, although it should be recognized that a GroupBy field may have fewer or more conditions as appropriate. Each condition 92 may represent a binary expression with a reference counter, where the reference counter indicates the number of subscriptions that reference the condition. A subscription 94 may represent a collection of all combinations of the conditions 92.

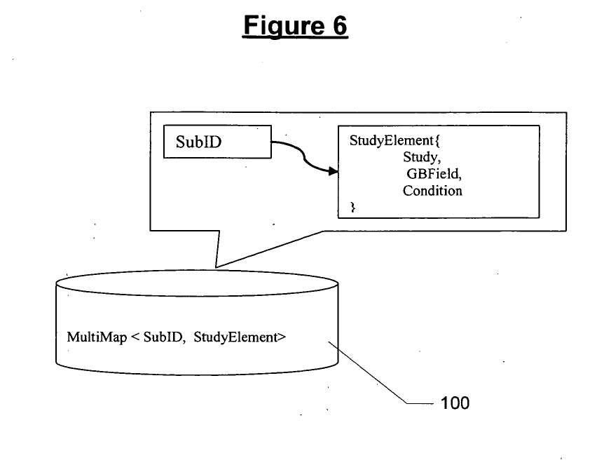

FIG. 6 is a diagram of a storage unit 100 for the DSPE engine 14 that stores the maps of the DSPE engine 14. The storage unit 100 may be a persistent storage such as, for example, a non-volatile storage such as a file system or a relational database or an object database. As shown in FIG. 6, a subscription may point to multiple study-GroupBy-condition combinations. The persistent storage may be used to recover the DSPE state after the server for the DSPE engine 14 crashes or experiences an unexpected termination.

Accordingly, embodiments of the present invention are directed to a method of managing dynamic studies comprising the steps of: (1) receiving a subscription request for one or more dynamic studies from a front end user at the DSPE engine 14; (2) validating the first subscription request at the DSPE engine 14; (3) locating, by the DSPE engine 14, one or more study templates in response to the subscription request; (4) generating, by the DSPE engine 14, the one or more dynamic studies based on the study templates; (5) uploading the dynamic studies from the DSPE engine 14 to aggregation engine 12; (6) creating, by the DSPE engine 14, a proxy subscription to the publication/subscription server 16; receiving, by the DSPE engine 14, a proxy subscription identifier from the publication/subscription server 16; (7) linking the dynamic studies with the first proxy subscription identifier; and (8) transmitting the proxy subscription identifier to the front end. As mentioned above, the step of locating the study templates in response to the subscription request may be performed using an internal dynamic study map. Also, if no study template exists, the DSPE engine 14 may create the study template(s) in response to the subscription request.

Also, embodiments of the present invention are directed to a dynamic study management system comprising: (1) a DSPE engine 14 that is configured to receive the subscription request for the dynamic studies from the front end user, validate the received subscription request, generating one or more dynamic studies based on one or more study templates, upload the one or more dynamic studies to the aggregation engine 12, and create a proxy subscription to the publication/subscription server 16; (2) the aggregation engine 12, which is configured to, among other things, produce one or more result objects in response to the dynamic studies; and (3) the publication/subscription server 16, which is configured to transmit a proxy subscription identifier to the DSPE engine 14.

As used herein, an “engine” may be considered a computer device or other piece of programmed hardware that is programmed to perform the described function(s). A processor or processors of the hardware may execute software code stored as a series of instructions or commands on a computer-readable medium in order to perform the described function(s).

The examples presented herein are intended to illustrate potential and specific implementations of the embodiments. It can be appreciated that the examples are intended primarily for purposes of illustration for those skilled in the art. No particular aspect or aspects of the examples is/are intended to limit the scope of the described embodiments.

It is to be understood that the figures and descriptions of the embodiments have been simplified to illustrate elements that are relevant for a clear understanding of the embodiments, while eliminating, for purposes of clarity, other elements. For example, certain operating system details and modules of network platforms are not described herein. Those of ordinary skill in the art will recognize, however, that these and other elements may be desirable in a typical processor or computer system. However, because such elements are well known in the art and because they do not facilitate a better understanding of the embodiments, a discussion of such elements is not provided herein.

In general, it will be apparent to one of ordinary skill in the art that at least some of the embodiments described herein may be implemented in many different embodiments of software, firmware and/or hardware. The software and firmware code may be executed by a processor or any other similar computing device. The software code or specialized control hardware which may be used to implement embodiments is not limiting. For example, embodiments described herein may be implemented in computer software using any suitable computer software language type, such as, for example, C or C++ using, for example, conventional or object-oriented techniques. Such software may be stored on any type of suitable computer-readable medium or media, such as, for example, a magnetic or optical storage medium. The operation and behavior of the embodiments may be described without specific reference to specific software code or specialized hardware components. The absence of such specific references is feasible, because it is clearly understood that artisans of ordinary skill would be able to design software and control hardware to implement the embodiments based on the present description with no more than reasonable effort and without undue experimentation.

Moreover, the processes associated with the present embodiments may be executed by programmable equipment, such as computers or computer systems and/or processors. Software that may cause programmable equipment to execute processes may be stored in any storage device, such as, for example, a computer system (non-volatile) memory, an optical disk, magnetic tape, or magnetic disk. Furthermore, at least some of the processes may be programmed when the computer system is manufactured or stored on various types of computer-readable media. Such media may include any of the forms listed above with respect to storage devices and/or, for example, a modulated carrier wave, to convey instructions that may be read, demodulated/decoded, or executed by a computer or computer system.

It can also be appreciated that certain process aspects described herein may be performed using instructions stored on a computer-readable medium or media that direct a computer system to perform the process steps. A computer-readable medium may include, for example, memory devices such as diskettes, compact discs (CDs), digital versatile discs (DVDs), optical disk drives, or hard disk drives. A computer-readable medium may also include memory storage that is physical, virtual, permanent, temporary, semi-permanent and/or semi-temporary. A computer-readable medium may further include one or more data signals transmitted on one or more carrier waves.

A “computer,” “computer system,” “host,” or “processor” may be, for example and without limitation, a processor, microcomputer, minicomputer, server, mainframe, laptop, personal data assistant (PDA), wireless e-mail device, cellular phone, pager, processor, fax machine, scanner, or any other programmable device configured to transmit and/or receive data over a network. Computer systems and computer-based devices disclosed herein may include memory for storing certain software applications used in obtaining, processing and communicating information. It can be appreciated that such memory may be internal or external with respect to operation of the disclosed embodiments. The memory may also include any means for storing software, including a hard disk, an optical disk, floppy disk, ROM (read only memory), RAM (random access memory), PROM (programmable ROM), EEPROM (electrically erasable PROM) and/or other computer-readable media.

In various embodiments disclosed herein, a single component may be replaced by multiple components and multiple components may be replaced by a single component to perform a given function or functions. Except where such substitution would not be operative, such substitution is within the intended scope of the embodiments. Any servers described herein, for example, may be replaced by a “server farm” or other grouping of networked servers that are located and configured for cooperative functions. It can be appreciated that a server farm may serve to distribute workload between/among individual components of the farm and may expedite computing processes by harnessing the collective and cooperative power of multiple servers. Such server farms may employ load-balancing software that accomplishes tasks such as, for example, tracking demand for processing power from different machines, prioritizing and scheduling tasks based on network demand and/or providing backup contingency in the event of component failure or reduction in operability.

While various embodiments have been described herein, it should be apparent that various modifications, alterations and adaptations to those embodiments may occur to persons skilled in the art with attainment of at least some of the advantages. The disclosed embodiments are therefore intended to include all such modifications, alterations and adaptations without departing from the scope of the embodiments as set forth herein.

What is claimed is:

1. A method of managing dynamic studies comprising:
receiving a subscription request from a front end for one or more dynamic studies;
validating the first subscription request;
locating one or more study templates in response to the first subscription request;
generating the one or more dynamic studies based on the one or more study templates;
uploading the one or more dynamic studies to an aggregation engine;
creating a proxy subscription to a publication and subscription server;
linking the one or more dynamic studies with the proxy subscription identifier; and
transmitting the proxy subscription identifier to the front end.

2. The method of claim 1, wherein in the step of locating one or more study templates in response to the subscription request is performed using an internal dynamic study map.

3. The method of claim 2, further comprising updating the internal dynamic study map upon transmission of the proxy subscription identifier to the front end.

4. The method of claim 2, further comprising creating the one or more study templates when the one or more study templates are not located in the internal dynamic study map.

5. The method of claim 1, further comprising incrementing a first reference counter in response to the first proxy subscription identifier.

6. The method of claim 1, further comprising generating one or more result objects in response to the one or more dynamic studies.

7. The method of claim 6, further comprising transmitting the one or more result objects to the publication and subscription server.

8. The method of claim 2, further comprising:
receiving a subscription status notification from the publication and subscription server, wherein the subscription status notification is generated in response to a request to unsubscribe from the one or more dynamic studies;
locating the one or more dynamic studies in response to the subscription status notification;
decrementing a first reference counter in response to the subscription status notification; and
when the first reference counter reaches a predetermined value, removing the one or more dynamic studies from the internal dynamic study map.

9. The method of claim 8, wherein the request to unsubscribe from the one or more dynamic studies is initiated by the front end.

10. The method of claim 9, wherein the step of locating the one or more dynamic studies in response to the subscription status notification is performing using the proxy subscription identifier.

11. The method of claim 10, further comprising, when the first reference counter reaches a predetermined value, transmitting a dynamic study delete command to the aggregation engine.

12. A method of managing dynamic studies in a data aggregation system comprising:
transmitting one or more subscription requests for one or more dynamic studies to a dynamic study proxy extension engine;
receiving one or more proxy subscription identifiers from the dynamic study proxy extension engine; and
subscribing to one or more dynamic study result topics using the one or more first proxy subscription identifiers.

13. The method of claim 12, further comprising transmitting a request to unsubscribe from the one or more dynamic studies.

14. The method of claim 13, wherein the request to unsubscribe from the one or more dynamic studies is initiated by the front end.

15. A dynamic study management system comprising:
a dynamic study proxy extension engine for receiving a subscription request for one or more dynamic studies from a front end, and generating a dynamic study from a study template based on the subscription request; and
an aggregation engine in communication with the dynamic study proxy extension engine, wherein the dynamic study proxy extension engine is for uploading the dynamic study to the aggregation engine, and the aggregation engine is for generating one or more result objects in based on the dynamic study.

16. The dynamic study management system of claim 15, further comprising a publication and subscription server in communication with the dynamic study-proxy extension engine and the aggregation engine.

17. The dynamic study management system of claim 16, wherein the dynamic study proxy extension engine is further for:
creating a proxy subscription to the publication and subscription server;
receiving a proxy subscription identifier from the publication and subscription server; and
linking the dynamic study to the proxy subscription identifier.

18. The dynamic study management system of claim 17, wherein the dynamic study proxy extension engine is further for transmitting the proxy subscription identifier to the front end.

19. The dynamic study management system of claim 18, wherein the dynamic study proxy extension engine is further for mapping the dynamic study to one or more users using an internal dynamic study map.

20. The dynamic study management system of claim 19, wherein the dynamic study proxy extension engine is further configured to create the study template when an existing study template for the subscription request is not located in the internal dynamic study map.
